(19) United States
(12) Patent Application Publication
(10) Pub. No.: US 2006/0070975 A1
(43) Pub. Date: Apr. 6, 2006

(54) Bottle with grooves on an inner side and injection molding method for making the bottle

(76) Inventor: Yu-Ching Shih, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/958,416

(22) Filed: Oct. 6, 2004

(51) Int. Cl. B65D 90/02; B29C 43/22; B29C 59/00

(52) U.S. Cl. 215/379; 264/509

(57) ABSTRACT

A bottle includes a main body, and a lateral part; the main body is made by means of injection molding, and it has an opening, a containing room communicating with the opening, a gap on a first lateral portion thereof, and grooves on an inner side of a second lateral portion, which faces the first lateral portion; the second part is also made by means of injection molding, and it has grooves thereon; the lateral part is closely fitted in the gap and secured to the main body with the grooves thereon facing the grooves of the main body.

### BACKGROUND OF THE INVENTION

1. Field of the invention

The present invention relates to a bottle for containing cosmetics therein, more particularly one, which has grooves on an inner side to be more attractive, and which can be manufactured with less time and labor and fewer steps.

2. Brief Description of the Prior Art

Common conventional bottles for cosmetics, e.g. the one shown in FIG. 4, are usually made by means of blow molding, according to which method materials are positioned in a mold, and air is made to blow into the mold for the materials to be molded as well as for forming rooms in the molded materials. Bottles with various shapes can be made by means of using different molds. However, such conventional bottles made by means of blow molding have uniform thickness and monotonous smooth inner sides therefore they are not attractive or pleasant looking. And, such bottles are very light, prone to fall over when being pushed or hit. Consequently, conventional bottles made by means of blow molding can no longer satisfy the consumers, and they are not convenient to use.

To overcome the above disadvantage, an additional outer transparent part is formed over a bottle by means of injection molding after the bottle has been made by means of blow molding; thus, a bottle is available, which consists of inner and outer parts respectively made by means of blow molding and injection molding, and which is more attractive and can stand steady. However, the above new method for making bottles still has disadvantages as followings:

1. The inner part of the bottle is prone to change shape owing to the large pressure from injection molding.

2. It takes two separate processes, i.e. blow molding and injection molding, to manufacture the bottle according to the method therefore it isn't economical.

### SUMMARY OF THE INVENTION

It is a main object of the present invention to provide an improvement on a bottle and a method for making same to overcome the above disadvantages.

The bottle of the present invention includes a main body, and a lateral part. The main body is made by means of injection molding, and it has an opening, a containing room communicating with the opening, a gap on a first lateral portion thereof, and several grooves on an inner side of a second lateral portion, which faces the first lateral portion. The second part is also made by means of injection molding, and it has several grooves thereon. The lateral part is closely fitted in the gap and secured to the main body with the grooves facing inwards.

### BRIEF DESCRIPTION OF THE DRAWINGS

The present invention will be better understood by referring to the accompanying drawings, wherein:

FIG. 1 is an exploded perspective view of the bottle according to the present invention,

FIG. 2 is a perspective view of the bottle of the present invention,

FIG. 3 is a vertical section of the bottle of the present invention, and

FIG. 4 is a perspective view of the conventional bottle.

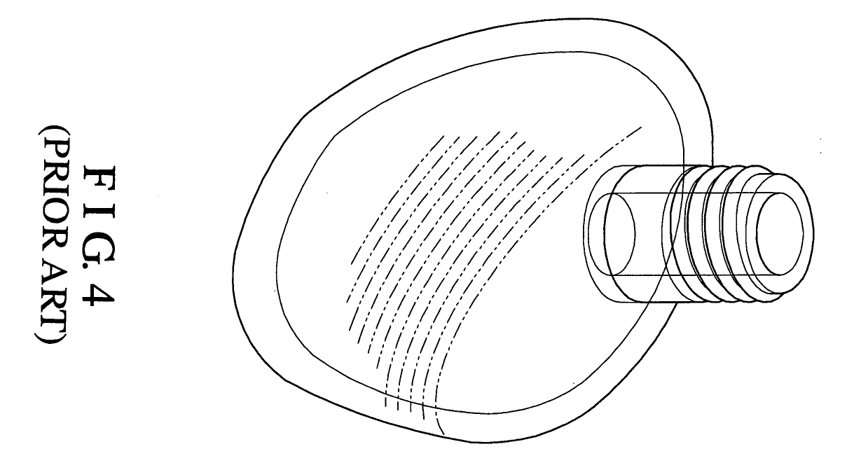

### DETAILED DESCRIPTION OF THE PREFERRED EMBODIMENTS

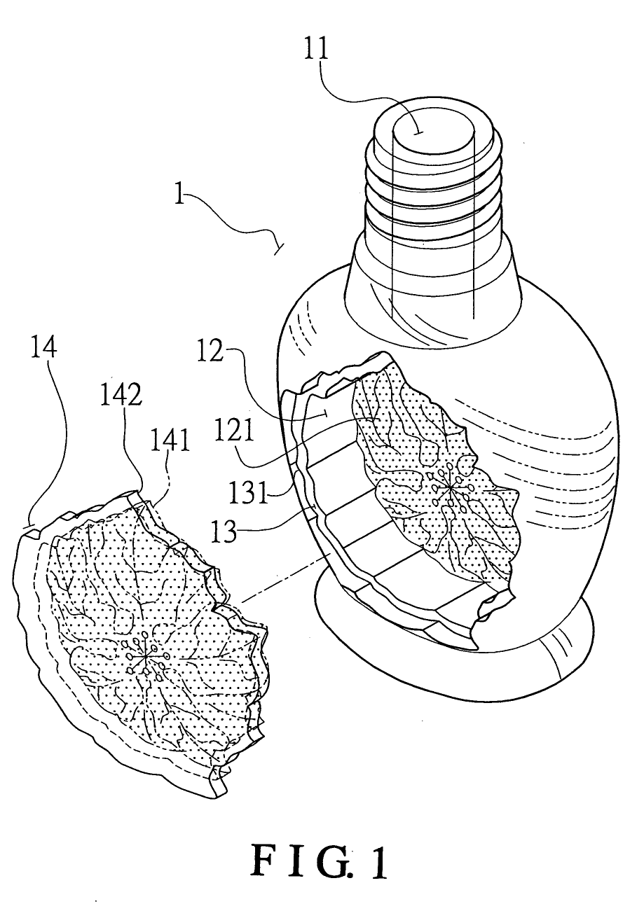

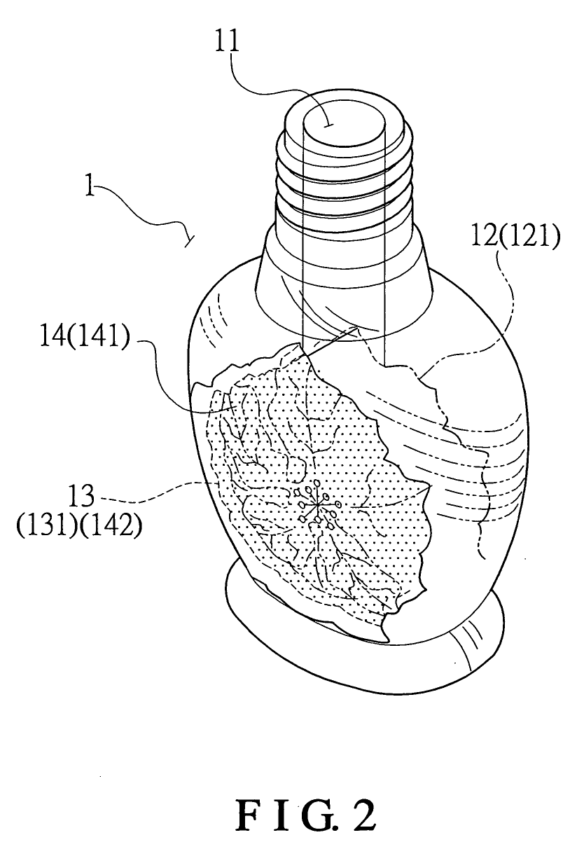

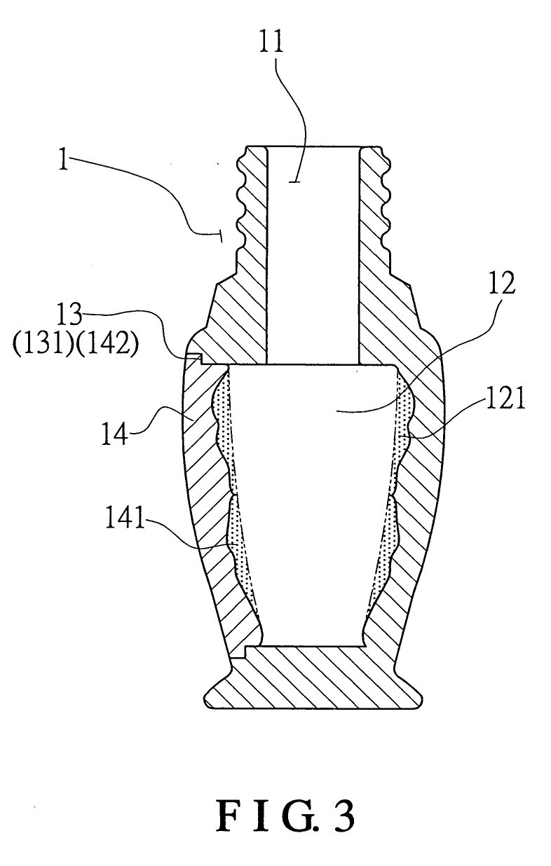

Referring to FIGS. 1 to 3, a preferred embodiment of a bottle of the present invention includes a main body 1, and a lateral part 2.

The main body 1 has an opening 11, a containing room 12 in communication with the opening 11, a gap 13 on a first lateral portion, and grooves 121 on an inner side of a second lateral portion, which have grooves 121 such a shape as to form patterns and drawings. In addition, the main body 1 has a locating portion 131 around the gap 13 thereof.

The main body 1 is made by means of injection molding and according to a method, which includes the following steps: (1) preparing a mold for the main body 1, which includes a main mold part, and a second mold part; the main mold part has a hole on a lateral side while the second mold part has raised lines on one end thereof; (2) passing a pin through an upper end of the main mold part, and passing the second mold part through the hole of the main mold part such that the raised lines of the second mold part is apart from and faces an inner side of the main mold part; (3) injecting materials into the mold; (4) separating the second mold part and the pin from the main mold part, and taking the molded material from the main mold part. Thus, the molded product has an opening formed on an upper end thereof owing to the pin, and has a holding room formed therein and a gap formed on a lateral portion thereof owing to the second mold part, and it has grooves formed on an inner side owing to the raised lines of the second mold part.

The lateral part 14 is also made by means of injection molding, and has a locating protrusion 142 on an edge, and grooves 141 forming patterns and drawings on an inner side thereof. The above mold for the main body 1 is formed with another molding portion for making the lateral part 14 with. And, the lateral part 14 can be made with another mold instead.

The lateral part 14 is closely fitted in the gap 13 and secured to the main body 1 by means of high frequency with the locating protrusion 141 thereof being pressed against the locating portion 131, and without seam on the joint. Thus, the bottle is more attractive with the grooves 121 and 131, which form patterns and drawings, on two opposing inner sides thereof.

From the above description, it can be easily understood that the bottle of the present invention has the following advantages:

1. The bottle has three-dimensional patterns and drawings on the inner sides therefore it is more attractive than common conventional bottles that have uniform thickness and a monotonous smooth inner side.

2. Only the injection molding method has to be used for manufacturing the bottle. Therefore, it takes fewer steps and less labor and time to manufacture the present bottle than it does to manufacture the conventional bottle, and the present bottle is more attractive and competitive than the conventional one.

What is claimed is:

1. A bottle made by means of injection molding and having grooves on an inner side, comprising
a main body made by means of injection molding; the main body having a containing room, and a gap on a first lateral portion thereof; the main body having a plurality of grooves on an inner side of a second lateral portion thereof; and
a second part made by means of injection molding; the second part being closely fitted in the gap and secured to the main body.

2. The bottle as claimed in claim 1, wherein the second part has a plurality of grooves on an inner side thereof.

3. The bottle as claimed in claim 1, wherein the main body has a locating portion around the gap thereof, and the lateral part has a locating protrusion on an edge thereof, which is pressed against the locating portion of the main body.

4. A method for making a bottle having grooves on an inner side with injection molding, comprising
(1) a first step: preparing a mold, which includes a main mold part, and a second mold part; the main mold part having a hole on a lateral side; the second mold part having a plurality of raised lines on one end thereof;
(2) a second step: passing the second mold part through the hole of the main mold part such that the raised lines of the second mold part is apart from and faces an inner side of the main mold part;
(3) a third step: injecting materials into the mold such that the material is molded into a main body of a bottle, which has a gap corresponding to the second mold part, and grooves corresponding to the raised lines of the second mold part;
(4) separating the second mold part from the main mold part, and taking the main body of the bottle from the main mold part;
(5) a fifth step: making a lateral part of the bottle by means of injection molding; and
(6) a sixth step: fitting the lateral part in the gap closely and securing the lateral part to the main body.
